(19) United States
(12) Patent Application Publication
(10) Pub. No.: US 2005/0147348 A1
(43) Pub. Date: Jul. 7, 2005

(54) Hitless variable-reflective tunable optical filter

(76) Inventors: Anders Grunnet-Jepsen, San Jose, CA (US); John Sweetser, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,774

(22) Filed: Dec. 30, 2003

(51) Int. Cl. G02B 6/34

(52) U.S. Cl. 385/37

(57) ABSTRACT

A variable-reflective tunable optical filter includes an interferometer adapted to control the powers of added or dropped signals and an optical waveguide grating to select the wavelength channels of the added or dropped signals. The waveguide grating is tunable to filter a dropped signal from an input data stream and filter an added signal into an output data stream. While a reflection band of the waveguide grating is being adjusted to tune a wavelength channel, the phase of at least one leg of the interferometer may be adjusted to direct signals of any wavelength channel selected by said waveguide from the input data stream to the output data stream, thereby providing hitless optical add-drop multiplexing.

### FIELD OF THE DISCLOSURE

This disclosure relates generally to the field of optical communications. In particular, the disclosure relates to an optical filter with a continuously variable reflectivity and tunable reflection band.

### BACKGROUND OF THE DISCLOSURE

Tunable optical filters may be used in multi-wavelength optical communications such as wavelength-division multiplexing (WDM) systems.

Currently, tunable optical filters may require a variable optical attenuator (VOA) or similar device for adjusting reflectivity. Such devices may not be spectrally selective. An arrayed waveguide grating (AWG) or similar device may be used to separate wavelength channels and an optical switching matrix may be used to add or drop selected channels. Thus the tuning and the switching in an optical filter may require a variety of these separate devices.

When an optical filter is tuned, it may inadvertently block a channel that should not be dropped. In such cases, it may be necessary to reinsert the blocked channel using an optical add-drop multiplexer (OADM) or similar device having optical switches between drop ports and add ports to add blocked channels that should not have been dropped. When the filter may be dynamically tuned to add or drop channels without inadvertently blocking other channels, it is referred to as being hitless.

In an optical communication network, it is desirable to tune an optical filter across multiple wavelength channels to selectively add or drop those channels. It is also desirable that the optical filter not affect or block other channels during tuning. Accomplishing both of these goals has been challenging, at times requiring additional switches to make an OADM hitless and additional attenuators for power balancing of the added and dropped channels.

### BRIEF DESCRIPTION OF THE DRAWINGS

The present invention is illustrated by way of example and not limitation in the figures of the accompanying drawings.

FIG. 1 illustrates one embodiment of variable-reflective tunable optical filters in an optical add-drop multiplexer (OADM).

FIG. 2 illustrates an adjustable output power of one embodiment of a variable-reflective tunable optical filter.

FIG. 3a-3d illustrate flow diagrams for alternative embodiments of processes to perform hitless tuning of variable-reflective tunable optical filters.

FIG. 4a-4b illustrate alternative embodiments of variable-reflective tunable optical filters in an OADM.

FIG. 5a-5b illustrate additional alternative embodiments of variable-reflective tunable optical filters in an OADM.

FIG. 6 illustrates an example embodiment of variable-reflective tunable optical filters in a wave-division multiplexing (WDM) system.

### DETAILED DESCRIPTION

Disclosed herein are processes and apparatus for variable-reflective tunable optical filtering. One embodiment of a variable-reflective tunable optical filter includes an interferometer adapted to control the magnitudes of added or dropped signals and an optical waveguide grating to select the wavelength channels of the added or dropped signals. The waveguide grating is tunable to filter a dropped signal from an input data stream and to filter an added signal into an output data stream. While a reflection band of the waveguide grating is being adjusted to tune a wavelength channel, the phase in a leg of the interferometer may be adjusted to direct signals of any wavelength channel selected by said waveguide from the input data stream into the output data stream, thereby providing hitless optical add-drop multiplexing.

These and other embodiments of the present invention may be realized in accordance with the following teachings and it should be evident that various modifications and changes may be made in the following teachings without departing from the broader spirit and scope of the invention. It will be appreciated that while examples presented below illustrate alternative embodiments of variable-reflective tunable optical filters in optical add-drop multiplexer (OADM) applications, the techniques disclosed are more broadly applicable. For example, optical receivers may make good use of the techniques herein disclosed to provide for audio and/or video broadcasts in a fiber cable system. As another example, sciences such as chemistry or medicine may make good use of the techniques for delivering pulses of precisely selected wavelengths of light, for example, to cause electronic transitions to or from specific energy levels or orbits around a nucleus. The specification and drawings are, accordingly, to be regarded in an illustrative rather than restrictive sense and the invention measured only in terms of the accompanying claims.

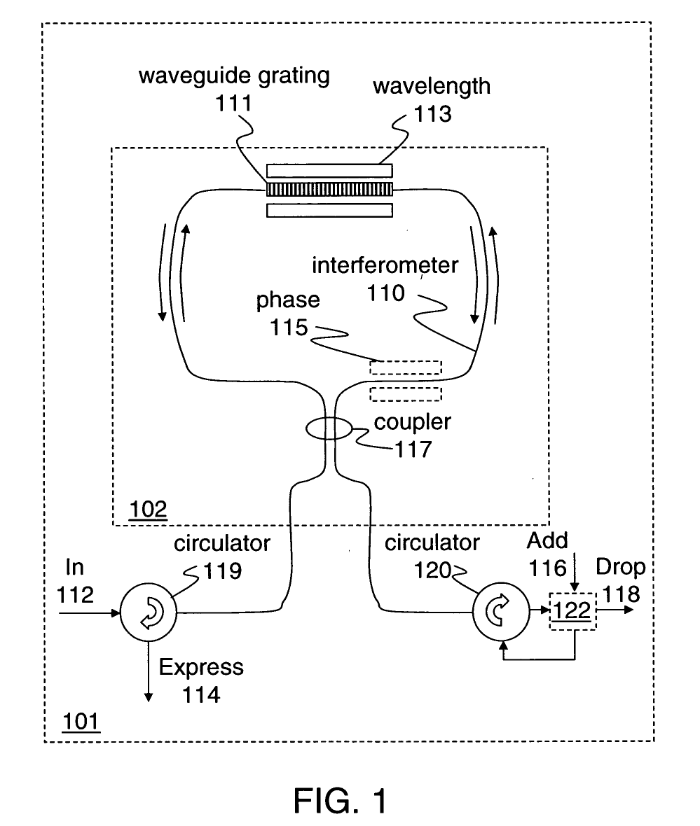

FIG. 1 illustrates one embodiment of a variable-reflective tunable optical filter 102 in an OADM 101. OADM 101 comprises In port 112 to receive an input wave-division multiplexing (WDM) data stream including a spectrum of wavelength channels, Express port 114 to output an express WDM data stream including the spectrum of wavelength channels, Add port 116 to receive an added signals of a specific wavelength channels, and Drop port 118 to output dropped signals of specific wavelength channels.

Variable-reflective tunable optical filter 102 comprises a Sagnac interferometer 110 including 50/50 coupler 117 to direct half of the incoming light in each direction around the Sagnac interferometer 110 and optical waveguide grating 111 to reflect specific wavelength channels of the input WDM data stream. Variable-reflective tunable optical filter 102 also comprises a wavelength adjustment circuit 113 to adjust or tune the reflection band of optical waveguide grating 111. For one embodiment of variable-reflective tunable optical filter 102, wavelength adjustment circuit 113 may comprise heaters to thermo-optically tune the reflection band of optical waveguide grating 111. For an alternative embodiment, wavelength adjustment circuit 113 may comprise a piezoelectric material for stress-optical tuning.

The wave length reflected by optical waveguide grating 111 is substantially equal to twice the product of the grating spacing times the effective index of refraction, the effective index of refraction being a weighted combination of the core's index of refraction and the cladding's index of refraction. For one alternative embodiment of variable-reflective tunable optical filter 102, wavelength adjustment circuit 113 may change the effective index of refraction by changing the index of refraction of the core and/or the index of refraction of the cladding to tune the reflection band of optical waveguide grating 111.

One embodiment of variable-reflective tunable optical filter 102 is a planar lightwave circuit wherein waveguide grating 111 is a Bragg grating that is written into the Sagnac interferometer 110 at a position to cause the two halves of a reflected wavelength channel to interfere with each other at coupler 117 as in a Michelson interferometer. For example, by centering waveguide grating 111 in Sagnac interferometer 110 with respect to coupler 117, interference of a first type may be caused at coupler 117. On the other hand, by placing waveguide grating 111 approximately one eighth of grating spacing off of center (approximately 50 nm to 90 nm may be effective in the shorter wavelengths of infrared, for example) in Sagnac interferometer 110, interference of a second type may be caused at coupler 117.

For one embodiment of variable-reflective tunable optical filter 102, the Sagnac interferometer 110 may comprise a quartz glass waveguide. For an alternative embodiment of variable-reflective tunable optical filter 102, the Sagnac interferometer 110 may comprise a silicon resin waveguide. It will be appreciated that waveguides may comprise a number of materials and/or metamaterials including but not limited to silicon, indium, phosphorus, gallium, arsenic, yttrium, vanadium, oxygen, photonic crystals, etc.

OADM 101 also comprises optical circulator 119. Optical circulator 119 transmits the input WDM data stream through coupler 117 and transmits an output WDM data stream from coupler 117 to Express port 114.

In operation two halves of each wavelength channel not in the reflection band of optical waveguide grating 111 transparently passes through optical waveguide grating 111 and interfere with each other at coupler 117 as in a Sagnac interferometer. For one embodiment of variable-reflective tunable optical filter 102, the wavelength channels from the input WDM data stream that are transmitted through to circulator 119 by coupler 117 interfere constructively. For one embodiment of variable-reflective tunable optical filter 102, waveguide grating 111 is written into Sagnac interferometer 110 at a position to cause the two halves of a reflected wavelength channel from the input WDM data stream to interfere with each other substantially opposite to the way that two halves of wavelength channels that are not in the reflection band of optical waveguide grating 111 interfere with each other at coupler 117. For one embodiment of variable-reflective tunable optical filter 102, the two halves of a reflected wavelength channel from the input WDM data stream that are transmitted through to circulator 119 by coupler 117 interfere destructively and therefore, are dropped by coupler 117.

Variable-reflective tunable optical filter 102 optionally comprises a phase adjustment circuit 115 to adjust the phase of at least one of the two halves of a reflected wavelength channel and thus to adjust the way the two halves interfere with each other at coupler 117. For one embodiment of variable-reflective tunable optical filter 102, phase adjustment circuit 115 may be used to adjust the phase of at least one of the two halves of a reflected wavelength channel in the Sagnac interferometer 110 to cause the two halves of the reflected wavelength channel from the input WDM data stream to interfere with each other substantially opposite to the way the two halves of wavelength channels that are not in the reflection band of optical waveguide grating 111 interfere with each other at coupler 117 and therefore to be dropped by coupler 117.

Add-drop multiplexer 101 also comprises optical circulator 120 and an optional 2×2 optical switch 122. Optical circulator 120 can transmit a wavelength channel dropped by coupler 117 through optional 2×2 optical switch 122 to Drop port 118. The 2×2 optical switch 122 can also transmit a wavelength channel from Add port 126 to circulator 120. Optical circulator 120 transmits the wavelength channel received from optional 2×2 optical switch 122 through coupler 117.

In operation the two halves of each wavelength channel received from optical circulator 120 behave symmetrically in Sagnac interferometer 110 to wavelength channels received through optical circulator 119, i.e. the two halves of each of the wavelength channels not in the reflection band of optical waveguide grating 111 transparently pass through optical waveguide grating 111 and, at coupler 117, are transmitted through circulator 120, interfering with each other constructively, to optional 2×2 switch 122. The two halves of a wavelength channel in the reflection band of optical waveguide grating 111 are reflected by optical waveguide grating 111 and, at coupler 117, light transmitted through circulator 119 to Express port 114 interfere with each other constructively, but light transmitted through circulator 120 interfere with each other destructively. Thus one signal of a wavelength channel in the reflection band of optical waveguide grating 111 may be dropped from a WDM data stream through coupler 117, circulator 120, optional 2×2 switch 122 and Drop port 118, and another signal in the reflection band of optical waveguide grating 111 may be added to the WDM data stream through Add port 116, optional 2×2 switch 122 and circulator 120.

While tuning the reflective band of waveguide grating 111, optional 2×2 switch 122 may be used to direct a dropped wavelength channel from the output of circulator 120 back to the input of circulator 120, thereby providing hitless tuning of add-drop multiplexer 101.

It will be appreciated that if variable-reflective tunable optical filter 102 comprises phase adjustment circuit 115, then by adjusting the phase of at least one of the two halves of a reflected wavelength channel the power and/or direction of an added or dropped signal may be controlled by adjusting the amount of constructive and destructive interference.

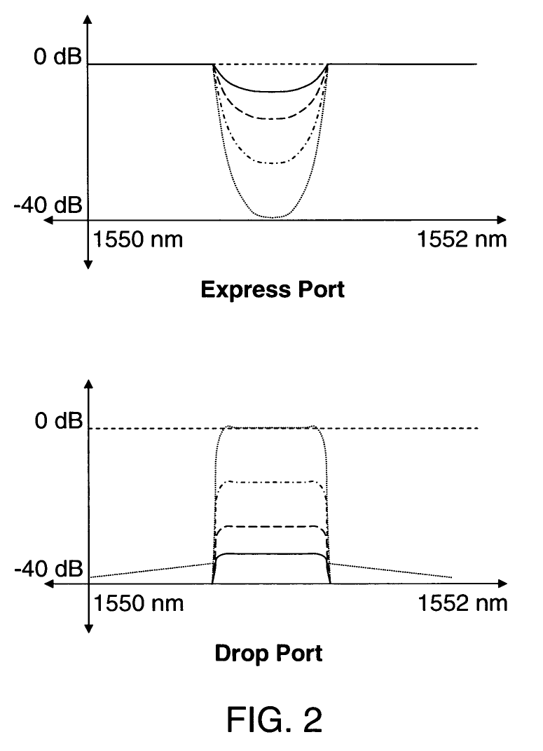

FIG. 2 illustrates an adjustable output power of one embodiment of a variable-reflective tunable optical filter. As the phase of one half of a reflected signal is continuously adjusted to cause interference that is closer to being substantially opposite the interference of the non-reflected signals, the power of reflected signal may be continuously shifted from the express port toward the drop port. For example, if the non-reflected input signals that are then seen on the express port interfere constructively at the coupler, then as half of the reflected signal is phase adjusted continuously toward more destructive interference at the express port, the power of the reflected signal is continuously shifted toward more constructive interference at the drop port. Conversely, as the phase of half of the reflected signal is continuously adjusted to cause interference that is more substantially matching the interference of the non-reflected signals, the power of the reflected signal is continuously shifted from the drop port toward the express port. While the above example illustrates applicability of adjusting the phase of at least one of the two halves of a reflected wavelength channel to control the power and/or direction of the signal in the infrared spectrum, it will be appreciated that the technique is more broadly applicable.

It will also be appreciated that exploiting this aspect of phase adjustment in a variable-reflective tunable optical filter, may provide adjustable reflectivity without additional devices such as variable optical attenuators. Further, using phase adjustment in a variable-reflective tunable optical filter may provide for hitless tuning in an add-drop multiplexer, for example, without requiring additional devices such as 2×2 optical switches.

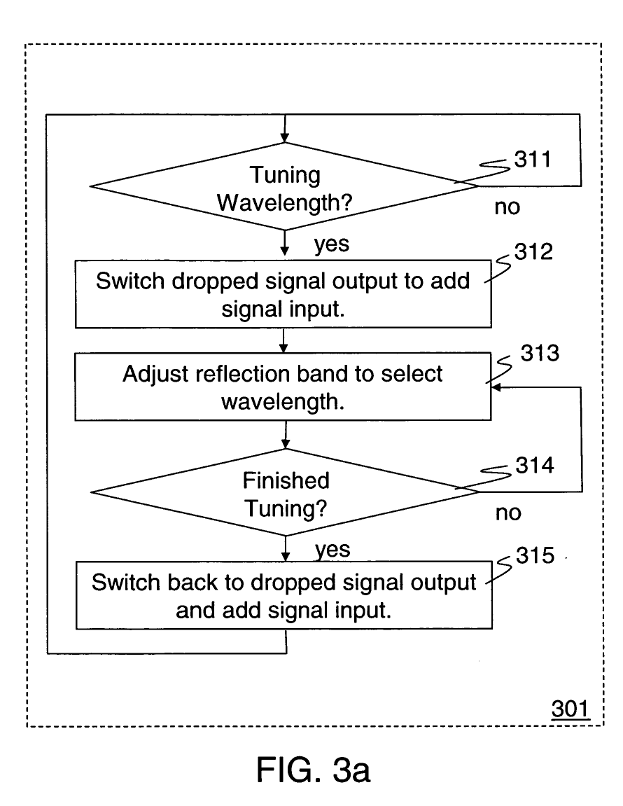

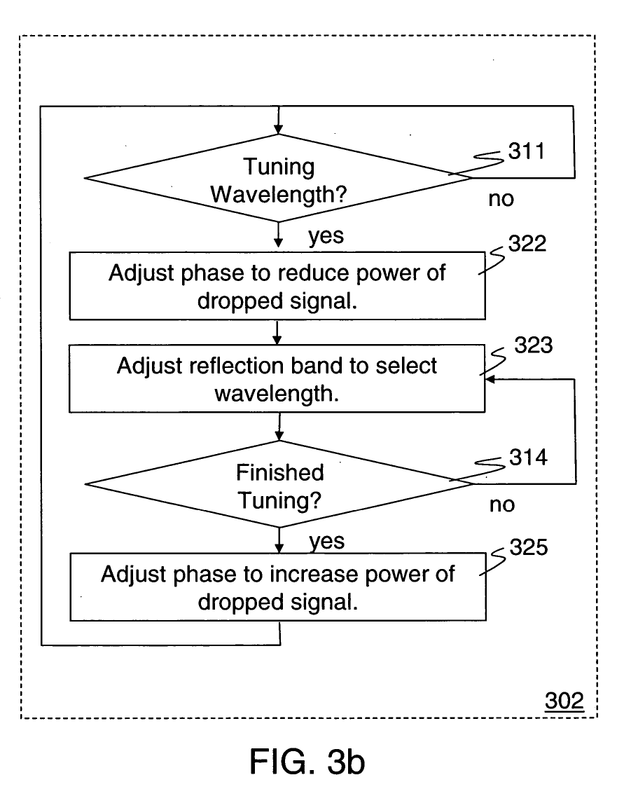

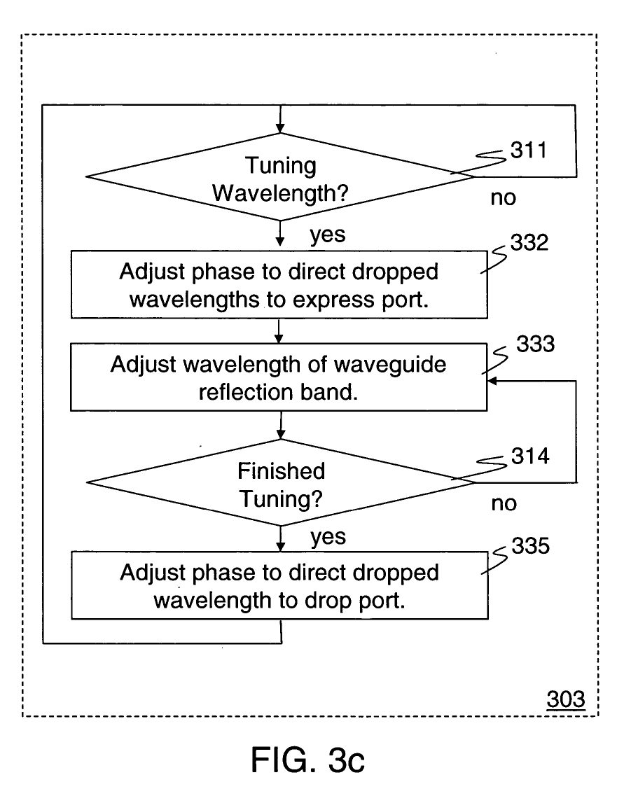

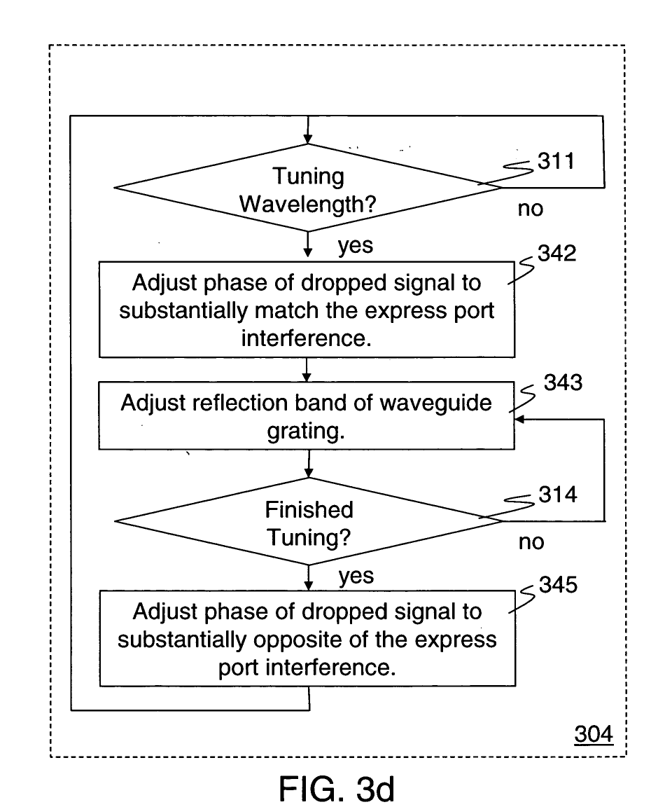

FIG. 3a illustrates a flow diagrams for one embodiment of a process 301 to perform hitless tuning of a variable-reflective tunable optical filter in accordance with FIG. 1. Process 301 and other processes herein disclosed are performed by processing blocks that may comprise dedicated hardware or software or firmware operation codes executable by general purpose machines or by special purpose machines or by a combination of both. It will be appreciated that while process 301 and other processes herein disclosed are illustrated, for the purpose of clarity, as processing blocks with a particular sequence, some operations of these processing blocks may also be conveniently performed in parallel, partially in parallel, or their sequence may be conveniently permuted so that the some operations are performed in different orders, or some operations may be conveniently performed out of order.

In processing block 311, a determination is made whether a new wavelength is to be tuned. If not processing continues in processing block 311. Otherwise processing proceeds to processing block 312 where a dropped signal output is switched to an add signal input. Processing then proceeds to processing block 313 where a waveguide reflection band is adjusted to select a wavelength for a new dropped signal. In processing block 314, a determination is made whether tuning to the desired wavelength is finished. If not processing continues in processing block 313. Otherwise processing proceeds to processing block 315 where the dropped signal is switched back to output and an add signal is switched back to input. Processing then proceeds to processing block 311.

FIG. 3b illustrates a flow diagrams for an alternative embodiment of a process 302 to perform hitless tuning of a variable-reflective tunable optical filter in accordance with FIG. 2. In processing block 311, a determination is made whether a new wavelength is to be tuned. If not processing continues in processing block 311. Otherwise processing proceeds to processing block 322 where a phase is adjusted in an interferometer to reduce the power of a dropped signal output. It will be appreciated that some embodiments of phase adjustment circuits may also benefit from automated correction through feedback, for example, or from pre-training to selected adjustment levels. Processing then proceeds to processing block 323 where a waveguide reflection band is adjusted to select a wavelength for a new dropped signal. In processing block 314, a determination is made whether tuning to the desired wavelength is finished. If not processing continues in processing block 323. Otherwise processing proceeds to processing block 325 where the phase is adjusted in said interferometer to increase the power of the dropped signal output. Processing then proceeds to processing block 311.

FIG. 3c illustrates a flow diagrams for another alternative embodiment of a process 303 to perform hitless tuning of a variable-reflective tunable optical filter. As before, a determination is made in processing block 311 whether a new wavelength is to be tuned and if not, processing continues in processing block 311. Otherwise processing proceeds to processing block 332 where a phase is adjusted in an interferometer to direct dropped wavelength channels an express port output. Processing then proceeds to processing block 333 where a waveguide reflection band is adjusted to a new wavelength. For some embodiments of a variable-reflective tunable optical filter, the waveguide grating is substantially symmetric. For alternative embodiments, the waveguide may be chirped. In processing block 314, a determination is made whether tuning to the desired wavelength is finished. If not processing continues in processing block 333. Otherwise processing proceeds to processing block 335 where the phase is adjusted in the interferometer to direct a dropped wavelength channel a drop port output. Processing then proceeds to processing block 311.

FIG. 3d illustrates a flow diagrams for another alternative embodiment of a process 304 to perform hitless tuning of a variable-reflective tunable optical filter. As before, a determination is made in processing block 311 whether a new wavelength is to be tuned and if not, processing continues in processing block 311. Otherwise in processing block 342 a phase of a dropped signal is adjusted to cause interference that substantially matches the interference of the non-reflected signals at an express port output. Processing then proceeds to processing block 343 where a waveguide grating reflection band is adjusted to reflect a new wavelength. In processing block 314, a determination is made whether tuning to the desired wavelength is finished. If not processing continues in processing block 343. Otherwise processing proceeds to processing block 345 where the phase of a dropped signal is adjusted to cause interference that is substantially opposite the interference of the non-reflected signals at the express port output. Processing then proceeds to processing block 311.

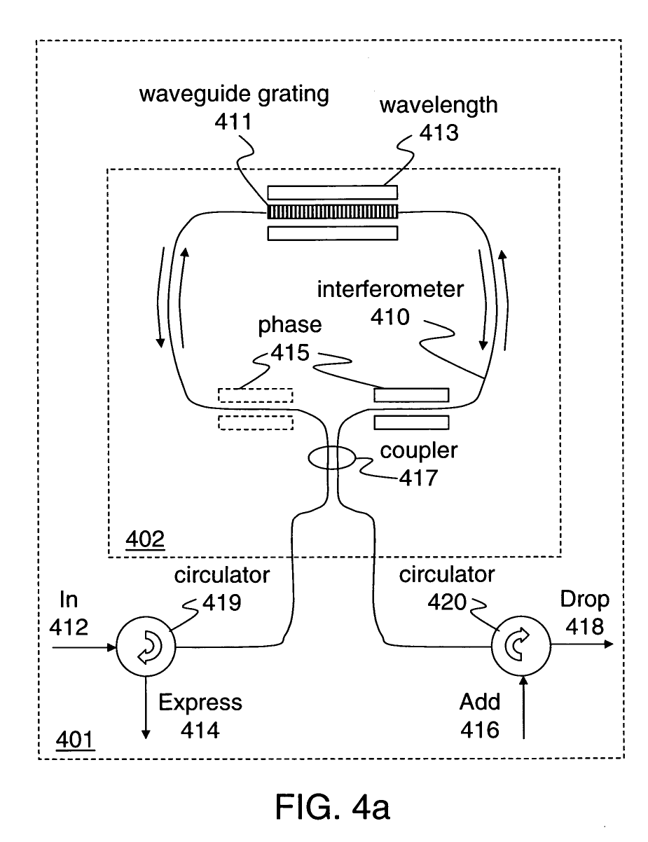

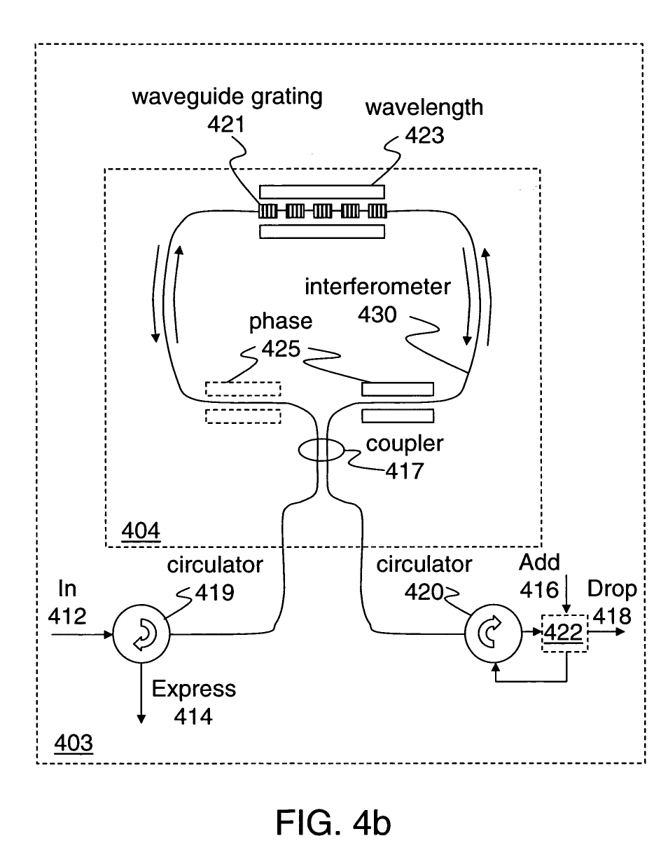

FIG. 4a illustrates an alternative embodiment of a variable-reflective tunable optical filter 402 in an OADM 401. OADM 401 comprises In port 412 to receive an input WDM data stream including a spectrum of wavelength channels, Express port 414 to output an express WDM data stream including the spectrum of wavelength channels, Add port 416 to receive an added signals of a specific wavelength channels, and Drop port 418 to output dropped signals of specific wavelength channels.

Variable-reflective tunable optical filter 402 comprises an interferometer 410 including 50/50 coupler 417 and optical waveguide grating 411. Variable-reflective tunable optical filter 402 also comprises a wavelength adjustment circuit 413 to tune the reflection band of optical waveguide grating 411. One embodiment of variable-reflective tunable optical filter 402 is a planar lightwave circuit containing a Sagnac interferometer 410 wherein waveguide grating 411 is a Bragg grating that is written into interferometer 110 at a position substantially equidistant in both directions from coupler 417.

OADM 401 also comprises optical circulators 419 and 420. Optical circulator 419 transmits the input WDM data stream through coupler 417 and transmits an output WDM data stream from coupler 417 to Express port 414. Optical circulator 420 transmits a wavelength channel dropped by coupler 417 through to Drop port 118 and transmits the wavelength channel received from Add port 126 through coupler 117.

In operation two halves of each wavelength channel not in the reflection band of optical waveguide grating 411 transparently pass through optical waveguide grating 411 and interfere with each other at coupler 417 as in a Sagnac interferometer to exit coupler 417 from the side they entered interfering with each other constructively.

Variable-reflective tunable optical filter 402 further comprises a phase adjustment circuit 415 to adjust the phase of at least one of the two halves of a reflected wavelength channel and thus to adjust the way the two halves interfere with each other at coupler 417. One embodiment of variable-reflective tunable optical filter 402 is a planar lightwave circuit containing a Sagnac interferometer 410 wherein waveguide grating 411 is written into interferometer 410 to make a Michelson interferometer 410 for wavelength channels in the reflective band of waveguide grating 411 and phase adjustment circuit 415 is adapted to adjust the phase of light in at least one of the legs of the Michelson interferometer 410.

For one embodiment of variable-reflective tunable optical filter 402, phase adjustment circuit 415 may be used to cause the two halves of the reflected wavelength channel from the input WDM data stream to interfere with each other substantially opposite to the way that two halves of wavelength channels not in the reflection band of optical waveguide grating 411 interfere with each other at coupler 417 and therefore to exit coupler 417 interfering with each other constructively on the side opposite the one that they entered. For an alternative embodiment of variable-reflective tunable optical filter 402, phase adjustment circuit 415 may be used to cause the two halves of the reflected wavelength channel from the input WDM data stream to interfere with each other at coupler 417 in such a way as to cause a portion of the power of the reflected wavelength channel to exit coupler 417 from the side opposite the one that it entered, and to cause a portion of the power of the reflected wavelength channel to exit coupler 417 from the same side that it entered. For one embodiment of variable-reflective tunable optical filter 402, phase adjustment circuit 415 may comprise a thermo-optic phase shifter to adjust the phase difference of the two halves of the reflected wavelength channel. For an alternative embodiment, phase adjustment circuit 415 may comprise a stress-optic phase shifter.

While tuning the reflective band of waveguide grating 411 the phase of light in at least one leg of the Michelson interferometer 410 may be adjusted by phase adjustment circuit 415 to provide hitless optical add-drop multiplexing by causing interference for wavelengths in the reflection band of optical waveguide grating 411 that substantially match the interference of non-reflected signals in the Sagnac interferometer 410. Thus the power of the dropped signal is substantially shifted from Drop port 418 to Express port 414. Symmetrically, the power of an added signal in the Sagnac interferometer 410 interferes constructively at Drop port 418 and is substantially shifted from Express port 414 to Drop port 418 when in the reflective band of waveguide grating 411 during tuning.

It will be appreciated that variable-reflective tunable optical filter 402 may provide continuously tunable filtering and hitless optical add-drop multiplexing without requiring a variety of separate devices, such as VOAs and optical switches. It will further be appreciated that wavelength adjustment circuit 413 and phase adjustment circuit 415 may be implemented using substantially the same technologies, therefore simplifying control circuitry.

FIG. 4b illustrate another alternative embodiment of a variable-reflective tunable optical filter 404 in an OADM 403. OADM 403 comprises In port 412, Express port 414, Add port 416, and Drop port 418. OADM 401 also comprises optical circulators 419 and 420. Variable-reflective tunable optical filter 404 comprises an interferometer 430 including 50/50 coupler 417 and optical waveguide grating 421. Variable-reflective tunable optical filter 404 also comprises a wavelength adjustment circuit 423 to tune the reflection band of optical waveguide grating 421 and a phase adjustment circuit 425 to adjust the phase of at least one of the two halves of a reflected wavelength channel to interfere with each other at coupler 417.

One embodiment of variable-reflective tunable optical filter 404 is a planar lightwave circuit containing a Sagnac interferometer 430 wherein a sampled waveguide grating 421 is written into interferometer 430 at a position substantially equidistant in both directions from coupler 417. For one embodiment of variable-reflective tunable optical filter 404, a distributed Bragg pulse shaping grating 421 is written into interferometer 430, for example, to directly modulate an added signal electronically. It will be appreciated that optical waveguide grating 421 may comprise any of a number of devices including but not limited to sampled Bragg gratings, coupled-waveguide filters, arrayed-waveguide gratings, holographic pulse shapers, volume holographic gratings, Fourier-plane pulse shapers, thin film filters, etc.

Add-drop multiplexer 403 also comprises optional 2×2 optical switch 422. Optical circulator 120 can transmit a wavelength channel dropped by coupler 417 through optional 2×2 optical switch 422 to Drop port 418. The 2×2 optical switch 422 can also transmit a wavelength channel from Add port 426 to circulator 420. Optical circulator 420 transmits the wavelength channel received from optional 2×2 optical switch 422 through coupler 417.

In operation two halves of each wavelength channel not in the reflection band of optical waveguide grating 421 may pass through optical waveguide grating 421 and exit coupler 417 from the side they entered interfering with each other constructively. The two halves of a wavelength channel in the reflection band of optical waveguide grating 421 are reflected by optical waveguide grating 421 and, at coupler 417, the waves of light transmitted through circulator 420 to Drop port 418 from optional 2×2 optical switch 422 interfere with each other constructively. Depending on the design of optical waveguide grating 421 the dropped wavelength channel may have received some wave shaping or inverse wave shaping.

While tuning the reflective band of waveguide grating 421, optional 2×2 switch 422 may be used to direct a dropped wavelength channel from the output of circulator 420 back to the input of circulator 420. The two halves of the dropped wavelength channel, being in the reflection band of optical waveguide grating 421 are reflected by optical waveguide grating 421 and retrace the same paths in the opposite directions through interferometer 430 thereby undoing any wave shaping or inverse wave shaping. At coupler 417, the waves of light transmitted through circulator 419 to Express port 414 interfere with each other constructively. Thus hitless tuning of add-drop multiplexer 403 may be accomplished.

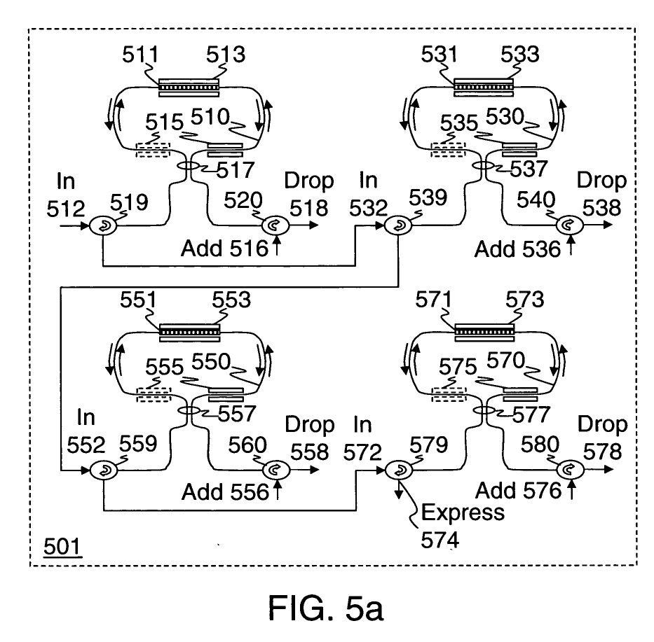

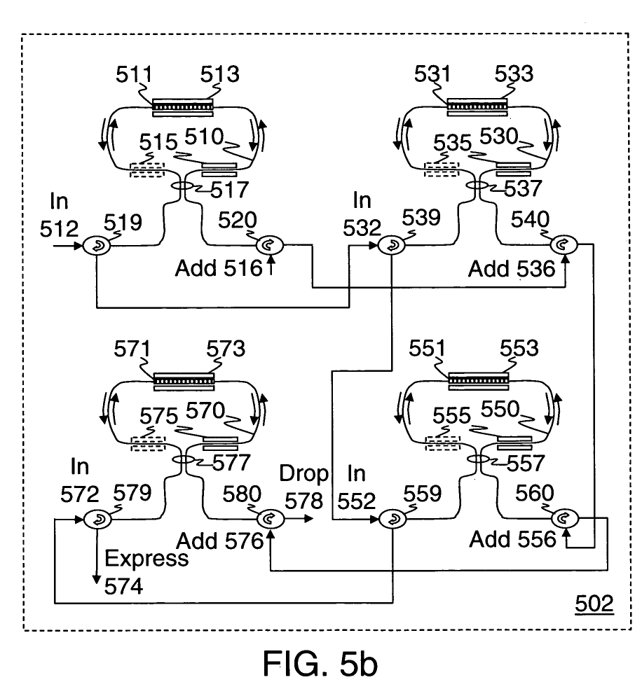

FIG. 5a illustrates another alternative embodiment of variable-reflective tunable optical filters in OADM 501. OADM 501 comprises In port 512 to receive an input WDM data stream including a spectrum of wavelength channels; Express port 574 to output an express WDM data stream including the spectrum of wavelength channels; Add ports 516, 536, 556 and 576; and Drop ports 518, 538, 558 and 578 each to output dropped signals of specific wavelength channels. OADM 501 also comprises optical circulators 519, 520, 539, 540, 559, 560, 579 and 580. In each of interferometers 510, 530, 550 and 570, the reflective bands of optical waveguide gratings 511, 531, 551 and 571 may be independently tuned by wavelength adjustment circuits 513, 533, 553 and 573 respectively; and the phase of at least one of the two halves of each reflected wavelength channel can be adjusted by phase adjustment circuits 515, 535, 555 and 575 to interfere with each other at couplers 517, 537, 557 and 575 respectively. The output WDM data stream from optical circulator 519 is routed to In port 532 of optical circulators 539. Similarly, the ouput WDM data stream from optical circulator 539 is routed to In port 552 of optical circulators 559 and the ouput WDM data stream from optical circulator 559 is routed to In port 572 of optical circulators 579. Thus the variable-reflective tunable optical filters are connected serially to provide hitless tunable adding/dropping of four wavelength channels to/from the WDM data stream received at In port 512.

FIG. 5b illustrates another alternative embodiment of variable-reflective tunable optical filters in an OADM 502. OADM 502 comprises In port 512 to receive an input WDM data stream including a spectrum of wavelength channels; Express port 574 to output an express WDM data stream including the spectrum of wavelength channels; Add port 516 to receive an input WDM data stream including a plurality of wavelength channels; and Drop port 578 to output a WDM data stream including the plurality of wavelength channels. OADM 502 also comprises optical circulators 519, 520, 539, 540, 559, 560, 579 and 580. In each of interferometers 510, 530, 550 and 570, the reflective bands of optical waveguide gratings 511, 531, 551 and 571 may be independently tuned by wavelength adjustment circuits 513, 533, 553 and 573 respectively; and the phase of at least one of the two halves of each reflected wavelength channel can be adjusted by phase adjustment circuits 515, 535, 555 and 575 to interfere with each other at couplers 517, 537, 557 and 575 respectively. As in OADM 501, the ouput WDM data stream from optical circulator 519 is routed to In port 532 of optical circulators 539, the ouput WDM data stream from optical circulator 539 is routed to In port 552 of optical circulators 559 and the ouput WDM data stream from optical circulator 559 is routed to In port 572 of optical circulators 579. In OADM 502, the ouput WDM data stream from optical circulator 520 is also routed to Add port 536 of optical circulators 540, the ouput WDM data stream from optical circulator 540 is routed to Add port 556 of optical circulators 560 and the ouput WDM data stream from optical circulator 560 is routed to Add port 576 of optical circulators 580. Thus the variable-reflective tunable optical filters are connected serially to provide hitless tunable adding/dropping of four wavelength channels to/from the WDM data stream received at In port 512 from/to the WDM data stream received at Add port 516.

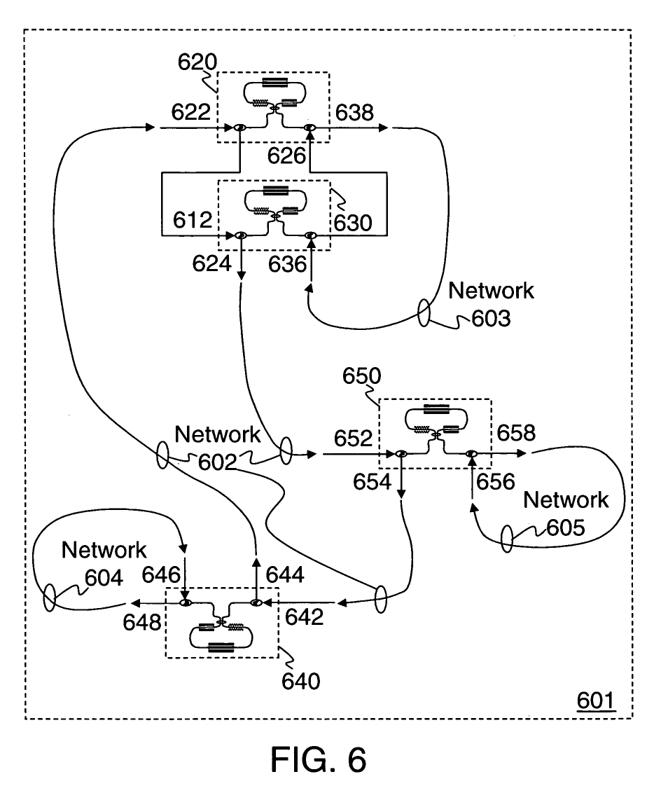

FIG. 6 illustrates an example embodiment of variable-reflective tunable optical filters in a WDM system 601. WDM system 601 comprises In port 622 to receive an input WDM data stream from Network 602 for variable-reflective tunable optical filter 620, Express port 624 to output an express WDM data stream from Network 602 from variable-reflective tunable optical filter 630, the express WDM data stream from variable-reflective tunable optical filter 620 being routed to In port 622 of variable-reflective tunable optical filter 630. WDM system 601 further comprises Add port 636 to receive a WDM data stream including added signals of specific wavelength channels from Network 603, and Drop port 638 to output a WDM data stream to Network 603 including dropped signals of specific wavelength channels from Network 602, the drop WDM data stream from variable-reflective tunable optical filter 630 being routed to Add port 626 of variable-reflective tunable optical filter 620. Thus the variable-reflective tunable optical filters 620 and 630 are connected serially to provide hitless tunable adding/dropping of two wavelength channels to/from the WDM data stream received at In port 622 from/to the WDM data stream received at Add port 636.

WDM system 601 further comprises In port 642 to receive an input WDM data stream from Network 602 for variable-reflective tunable optical filter 640, Express port 644 to output an express WDM data stream to Network 602 from variable-reflective tunable optical filter 640, Add port 646 to receive at least one or more added signals of specific wavelength channels from a WDM data stream of Network 604, and Drop port 648 to output at least one or more dropped signals of specific wavelength channels to the WDM data stream of Network 604. Thus the variable-reflective tunable optical filter-640 provides hitless tunable adding/dropping of one wavelength channel to/from the WDM data stream received at In port 642 from/to the one or more added signals received at Add port 646 from the WDM data stream of Network 604.

WDM system 601 further comprises In port 652 to receive an input WDM data stream from Network 602 for variable-reflective tunable optical filter 650, Express port 654 to output an express WDM data stream to Network 602 from variable-reflective tunable optical filter 650, Add port 656 to receive at least one or more added signals of specific wavelength channels from a WDM data stream of Network 605, and Drop port 658 to output at least one or more dropped signals of specific wavelength channels to the WDM data stream of Network 605. Thus the variable-reflective tunable optical filter 650 provides hitless tunable adding/dropping of one wavelength channel to/from the WDM data stream received at In port 652 from/to the one or more added signals received at Add port 656 from the WDM data stream of Network 605.

It will be appreciated that in WDM system 601, Network 603 may share two wavelength channels in common with Network 602, one of which may or may not be a wavelength channel shared between Network 604 and Network 602 and/or between Network 605 and Network 602. Networks 602 and/or 603 may comprise two wavelength channels or may comprise a WDM data stream of 40, 52, or more wavelength channels. Similarly Networks 604 and/or 605 may comprise a single wavelength channel or may comprise a WDM data stream of 40, 52, or more wavelength channels. It will be appreciated that WDM system 601 provides hitless tunable adding/dropping of any of the wavelength channels between the WDM data stream of Networks 602, 603, 604 and 605.

The above description is intended to illustrate preferred embodiments of the present invention. From the discussion above it should also be apparent that especially in such an area of technology, where growth is fast and further advancements are not easily foreseen, the invention may be modified in arrangement and detail by those skilled in the art without departing from the principles of the present invention within the scope of the accompanying claims.

1. A method comprising:
adjusting a phase of an interferometer to reduce the power of an added or dropped signal;
adjusting a waveguide reflection band to select a wavelength of said added or dropped signal; and
adjusting the phase of said interferometer to increase the power of said added or dropped signal.

2. The method of claim 1 wherein adjusting said waveguide reflection band is accomplished by changing an index of refraction of the waveguide.

3. The method of claim 2 wherein adjusting said waveguide reflection band is accomplished by heating silica comprising the waveguide.

4. The method of claim 1 wherein adjusting said waveguide reflection band is accomplished by changing a grating period of the waveguide.

5. The method of claim 1 wherein adjusting the phase of said interferometer is accomplished by changing a length of an arm of the interferometer.

6. The method of claim 1 wherein adjusting the phase of said interferometer is accomplished by changing an index of refraction of the interferometer.

7. The method of claim 6 wherein adjusting the phase of said interferometer is accomplished by heating silica comprising the waveguide.

8. The method of claim 1 further comprising:
adjusting the phase of said interferometer to direct any wavelength reflected to an express port while adjusting the waveguide reflection band to select the wavelength of the added or dropped signal.

9. An apparatus comprising:
a waveguide grating to select a wavelength of an added or dropped signal; and
an interferometer to control the power of said added or dropped signal.

10. The apparatus of claim 9 wherein said waveguide grating is written in said interferometer.

11. The apparatus of claim 10 wherein said waveguide grating is a Bragg grating.

12. The apparatus of claim 11 wherein said interferometer is a planar lightwave circuit Sagnac interferometer.

13. The apparatus of claim 9 further comprising:
a first set of heaters to adjust a reflection band for the waveguide grating; and
a second set of heaters to adjust a phase for the interferometer.

14. The apparatus of claim 9 further comprising:
a first optical circulator coupled with said waveguide grating and said interferometer to receive input signals for said waveguide grating and said interferometer and to receive express signals from said waveguide grating and said interferometer; and
a second optical circulator coupled with said waveguide grating and said interferometer to receive added signals for said waveguide grating and said interferometer and to receive dropped signals from said waveguide grating and said interferometer.

15. An apparatus comprising:
an interferometer to control the power of an added signal or a dropped signal, the interferometer including an optical waveguide grating to select a first wavelength channel of the added signal or the dropped signal and to filter the dropped signal from an input data stream and to multiplex the added signal into an output data stream, a phase of said interferometer being adjusted to provide hitless optical add-drop multiplexing when a reflection band of said waveguide grating is being adjusted to select said first wavelength channel.

16. The apparatus of claim 15 further comprising:
a set of heaters operatively coupled to the interferometer to adjust the reflection band of the waveguide grating or the phase of the interferometer.

17. An apparatus comprising:
a Sagnac interferometer comprising a waveguide grating to select a wavelength of an added or dropped signal; and
a phase adjustment circuit coupled with said Sagnac interferometer to control the power of said added or dropped signal.

18. The apparatus of claim 17 wherein said waveguide grating is a Bragg grating.

19. The apparatus of claim 17 wherein said waveguide grating is distributed.

20. The apparatus of claim 17 wherein said phase adjustment circuit comprises a heater.

21. The apparatus of claim 17 wherein said phase adjustment circuit is piezoelectric.

22. The apparatus of claim 17 further comprising:
a frequency adjustment circuit coupled with said waveguide grating to tune the frequency of said added or dropped signal.

23. The apparatus of claim 22 wherein said frequency adjustment circuit comprises a heater.

24. The apparatus of claim 22 wherein said frequency adjustment circuit is piezoelectric.

25. The apparatus of claim 17 further comprising:
a frequency adjustment circuit coupled with said waveguide grating to tune a reflection band of said waveguide grating to select the wavelength of said added or dropped signal; and
a phase adjustment circuit coupled with said Sagnac interferometer to provide hitless optical add-drop multiplexing when the reflection band of said waveguide grating is being tuned.

26. A system comprising:
a first port to receive an input wave-division multiplexing (WDM) data stream including a plurality of wavelength channels;
a second port to output an express WDM data stream including said plurality of wavelength channels;
a third port to receive an added signal of a first wavelength channel of said plurality of wavelength channels;
a fourth port to output a dropped signal of the first wavelength channel; and
a Sagnac interferometer to control the power of said added or dropped signal, said Sagnac interferometer comprising an optical waveguide grating to select the first wavelength channel of said added or dropped signal and to filter said dropped signal from the input WDM data stream and said added signal to the express WDM data stream.

27. The system of claim 26 wherein a phase of said Sagnac interferometer is adjusted to direct a signal of any wavelength channel selected by said optical waveguide grating from the input WDM data stream to the express WDM data stream while a reflection band of the optical waveguide grating is being adjusted to select the first wavelength channel.

28. The system of claim 26 wherein said optical waveguide grating is a tunable Bragg grating.

29. An apparatus comprising:
a Sagnac interferometer including a beam-splitting coupler;
a Michelson interferometer including said beam-splitting coupler and a waveguide grating to reflect a first wavelength; and
a phase shifter coupled with said Michelson interferometer to adjust the interference of the first wavelength at said beam-spitting coupler between a destructive interference and a constructive interference.

30. The apparatus of claim 29 wherein said waveguide grating is tunable.

31. The apparatus of claim 30 wherein said waveguide grating is a Bragg grating.

32. The apparatus of claim 30 wherein said waveguide grating is segmented.

33. The apparatus of claim 29 wherein said Sagnac interferometer is a planar lightwave circuit interferometer.

34. The apparatus of claim 33 wherein said Michelson interferometer is the same planar lightwave circuit interferometer.

35. The apparatus of claim 34 wherein said planar lightwave circuit interferometer comprises a quartz glass waveguide.

36. The apparatus of claim 34 wherein said planar lightwave circuit interferometer comprises a silicon resin waveguide

37. The apparatus of claim 29 wherein said phase shifter is a thermo-optic phase shifter.

38. The apparatus of claim 29 wherein said phase shifter is a stress-optic phase shifter.

39. A wave-division multiplexing (WDM) system comprising:
a plurality of Sagnac interferometers, each of said plurality of Sagnac interferometers respectively comprising a waveguide grating to reflect a wavelength of a respective added or dropped channel and a phase adjustment circuit coupled with said Sagnac interferometer to control the power of said added or dropped signal.

40. The system of claim 39 wherein a respective phase of each of said plurality of Sagnac interferometers is adjustable to direct signals of any wavelength reflected by said waveguide from an input WDM data stream to an express WDM data stream while a reflection band of the waveguide grating is being adjusted to reflect the wavelength of the respective added or dropped channel.
